(19) United States
(12) Patent Application Publication
(10) Pub. No.: US 2008/0257693 A1
(43) Pub. Date: Oct. 23, 2008

(54) SWITCH DEVICE AND LENS-FITTED PHOTO FILM UNIT

(75) Inventor: Shintaro Tadokoro, Minami-Ashigara-shi (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 11/935,596

(22) Filed: Nov. 6, 2007

(30) Foreign Application Priority Data
Nov. 6, 2006 (JP) 2006-299837

(51) Int. Cl. H01H 9/28

(52) U.S. Cl. 200/43.01

(57) ABSTRACT

A lens-fitted photo film unit includes a front cover which covers an outside of a main body. A flash light source is secured to the main body. A sliding mechanism for switching is kept slidable on the main body, for generating a signal to actuate the flash light source. A button projection is formed to project from the sliding mechanism, and positioned externally through an opening of the front cover. A positioning projection is formed on an inside of the front cover, has an engaging surface oriented crosswise to a sliding direction of the sliding mechanism. A lock arm is disposed on the sliding mechanism, has a contact surface for engagement with the engaging surface, to lock the sliding mechanism. When the button projection is pressed toward the main body, the sliding mechanism is deformed flexibly, and unlocked by disengagement of the lock arm.

### BACKGROUND OF THE INVENTION

1. Field of the Invention

The present invention relates to a switch device and a lens-fitted photo film unit. More particularly, the present invention relates to a switch device which is a sliding type and with which a light source can be reliably changed over by turning on and off distinctly, and a lens-fitted photo film unit.

2. Description Related to the Prior Art

Cameras are electric instruments having a light source, and include a lens-fitted photo film unit, compact camera, digital still camera and the like. A flash unit is incorporated as the light source, for photographing an image with a small light amount, for example, indoors or in other dim places. The flash unit includes a main capacitor for boosting voltage of a battery as a power source in a camera. Electric energy stored in the main capacitor is discharged through a xenon tube or flash discharge tube for emitting flash light. A switch device is incorporated in the camera for turning on or off the flash emission of the flash unit. A button portion of the switch mechanism appears externally through a front cover.

In FIG. 6, an example of a switch mechanism 61 for a flash unit in a lens-fitted photo film unit is illustrated. A rail 63b is formed on a receiving panel 63 fitted on a main body of the lens-fitted photo film unit. The switch mechanism 61 moves along the rail 63b. The switch mechanism 61 includes a button projection 61a and a support 61b. A lock portion 61c is formed on the support 61b, and is deformable in response to pressure. A projection 61d is formed on the center of the lock portion 61c.

A projection 63a is formed with the receiving panel 63. While the switch mechanism 61 is moved from the off position to the on position by pushing the button projection 61a, the projection 61d moves past the projection 63a by deforming the lock portion 61c flexibly.

If an amount of engagement of the projection 61d with the projection 63a is set small, there occurs incidental turning on of the switch mechanism 61. Specifically when a user carries the lens-fitted photo film unit in a bag, pocket or the like, the switch mechanism 61 may be shifted by friction or the like. The battery may be used up with time after the incidental turning on of the switch mechanism 61.

If an amount of engagement of the projection 61d with the projection 63a is set large, a force applied for pushing the button projection 61a become high. The support 61b becomes flexed by the force to the button projection 61a. Thus, an amount of engagement of the projection 61d with the projection 63a will be large. There occurs requirement for still higher force of operation. The problem of a still greater amount of engagement remains without solution.

In FIG. 7, a switch mechanism 65 of JP-A 2002-357860 is illustrated. A button projection 65a and a projection 67a are oriented horizontally. A lock portion 65c flexes when the projection 65d moves past the projection 67a. The flexing direction of the lock portion 65c is set perpendicular to a direction of flexing of a support panel 65b at the time of pressure to a projection 65d of the switch mechanism 65. An amount of force of operation in moving the switch mechanism 65 is kept free from influence of flexing of the support panel 65b.

However, an amount of engagement of the projection 65d with the projection 67a must be set large in FIG. 7 to prevent incidental turning on of the switch mechanism. There is a problem in greatness of the force for operation of the switch mechanism.

### SUMMARY OF THE INVENTION

In view of the foregoing problems, an object of the present invention is to provide a switch device which is a sliding type and with which a light source can be reliably changed over by turning on and off distinctly, and a lens-fitted photo film unit.

In order to achieve the above and other objects and advantages of this invention, a switch device includes an operation projection disposed to project through an outer cover for covering a main body having a light source, the operation projection being slid to turn on and off a power source of the light source. A sliding mechanism has a front surface where the operation projection is formed, and has a flexible support panel of which two lateral edges are set on a front surface of the main body in a slidable manner, there being a space between the support panel and the main body behind the operation projection, the support panel being movable between on and off positions with the operation projection inside the outer cover. A switch is disposed on the main body, for turning off the power source when the sliding mechanism is in the off position, and for turning on the power source when the sliding mechanism is shifted to the on position from the off position. A positioning projection is disposed to project from an inner surface of the outer cover toward the sliding mechanism, and having an engaging face oriented crosswise to moving of the sliding mechanism. A lock portion is formed on the support panel, and having a contact surface for contacting the engaging face when the sliding mechanism is in the off position, to prevent the sliding mechanism from moving toward the on position. When the operation projection is pressed toward the main body while the sliding mechanism is in the off position, the support panel flexes toward the main body to shift the lock position toward the main body, and the sliding mechanism is allowed to move to the on position by disengagement of the contact face from the engaging face.

The positioning projection has a second engaging face formed in a position in a sliding direction of the sliding mechanism, and oriented opposite from the engaging face. The lock portion has a second contact face for contacting the second engaging face. While the sliding mechanism is in the on position, the support panel in pressing the operation projection toward the main body flexes toward the main body, to shift the lock portion toward the main body, to allow the sliding mechanism to move to the off position by disengaging the second contact face from the second engaging face.

Furthermore, a flexible lock arm has a proximal end formed on the support panel, is disposed to extend in the sliding direction, and has a distal end where the lock portion is formed.

A slot is formed in the support panel, and the lock arm projects from one end of the slot and extends along the slot.

Furthermore, a light source circuit charges power for the light source, wherein the switch turns on and off the light source circuit.

In a preferred embodiment, a lens-fitted photo film unit includes a main body. An outer cover covers an outside of the main body. A flash light source is secured to the main body. A sliding mechanism for switching is kept slidable on the main body, for generating a signal to actuate the flash light source. An operation projection is formed to project from the sliding mechanism, and positioned externally through an opening of the outer cover. A positioning projection is formed on an inside of the outer cover, has an engaging surface oriented crosswise to a sliding direction of the sliding mechanism. A lock portion is disposed on the sliding mechanism, has a contact surface for engagement with the engaging surface, to lock the sliding mechanism. When the operation projection is pressed toward the main body, the sliding mechanism is deformed flexibly, and unlocked by disengagement of the lock portion.

Consequently, the light source can be reliably changed over by turning on and off distinctly, because of locking of the slide of the sliding mechanism by the positioning projection and the lock portion.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a lens-fitted photo film unit;

FIG. 2 is an exploded perspective view illustrating the lens-fitted photo film unit;

FIG. 3 is an exploded perspective view illustrating a state of the lens-fitted photo film unit before setting a sliding mechanism;

FIG. 4A is an explanatory view illustrating the sliding mechanism in an off position;

FIGS. 4B, 4C and 4D are explanatory views illustrating the sliding mechanism in a sequence between the on and off positions;

FIG. 4E is an explanatory view illustrating the sliding mechanism in an on position;

FIG. 5 is a circuit diagram schematically illustrating a flash device;

FIG. 6 is an exploded perspective view illustrating a switch device of the prior art; and

FIG. 7 is an exploded perspective view illustrating another switch device of the prior art.

### DETAILED DESCRIPTION OF THE PREFERRED EMBODIMENT(S) OF THE PRESENT INVENTION

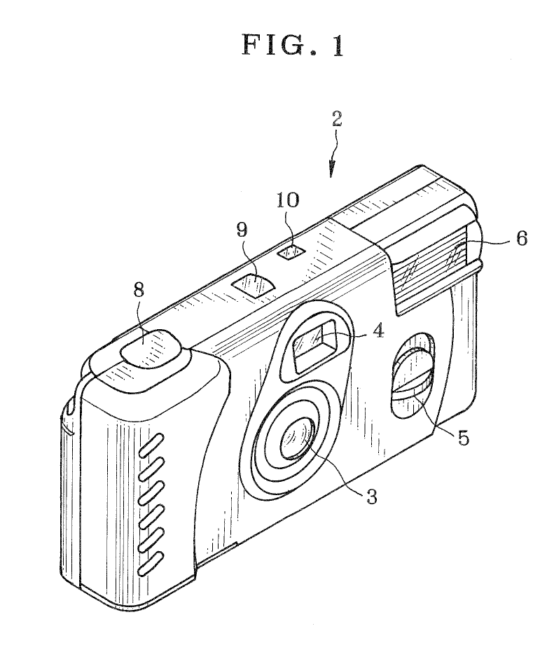

In FIG. 1, a lens-fitted photo film unit 2 or camera as electric instrument is illustrated. Plural elements are disposed on the front of the lens-fitted photo film unit 2, including a taking lens 3, an objective viewfinder window 4, a sliding mechanism 5 in a switch device, and a flash light source 6. An upper face of the lens-fitted photo film unit 2 has a shutter release button 8, a frame counter window 9, and a flash indicator 10 for indicating readiness of the flash device.

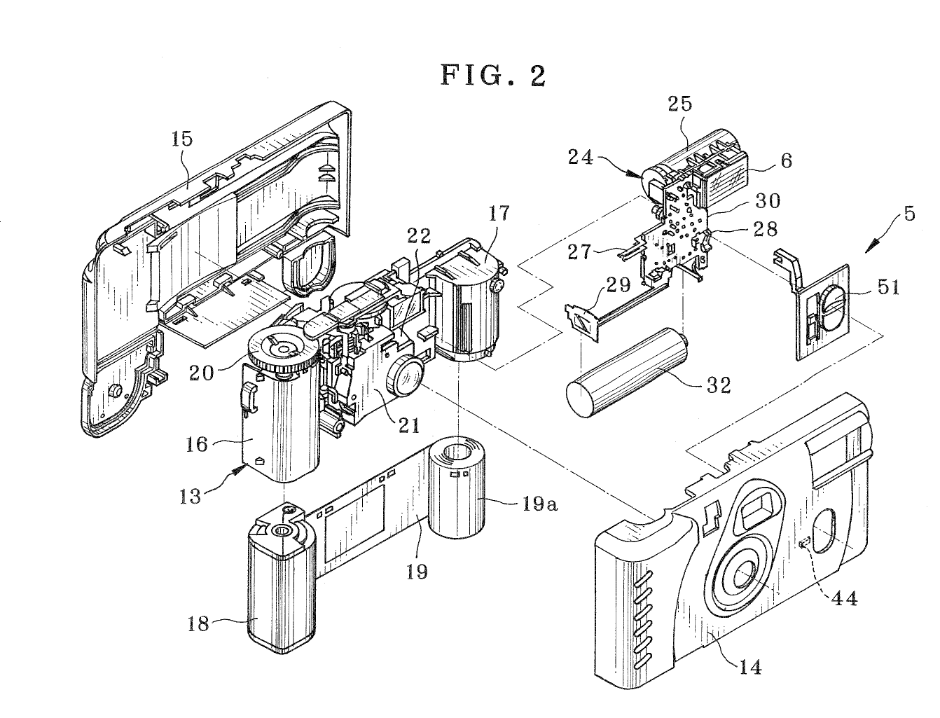

In FIG. 2, the lens-fitted photo film unit 2 includes a main body 13, and a front cover 14 and a rear cover 15 to cover the main body 13 as outer cover. There are a cassette holder chamber 16 and a photo film holder chamber 17 on lateral sides of the main body 13. The cassette holder chamber 16 is loaded with a photo film cassette 18. The photo film holder chamber 17 is loaded with a photo film roll 19a which is formed by advance of a photo film 19 from the photo film cassette 18. A winder or wheel 20 is disposed on the top of the cassette holder chamber 16. A shaft protrudes down from the winder 20 for engagement with a spool of the photo film cassette 18. When the winder 20 rotates in a counterclockwise direction, the photo film 19 becomes wound into the space in the photo film cassette 18.

A light tunnel 22 is disposed between the cassette holder chamber 16 and the photo film holder chamber 17 and shields a light path from ambient light. Various elements are associated with the light tunnel 22, including a shutter mechanism, a one-frame advance mechanism, a frame counter mechanism, a viewfinder and the like. An exposure opening is formed in the center of the light tunnel 22. A lens holder 21 and a shutter blade are disposed on the front of the exposure opening.

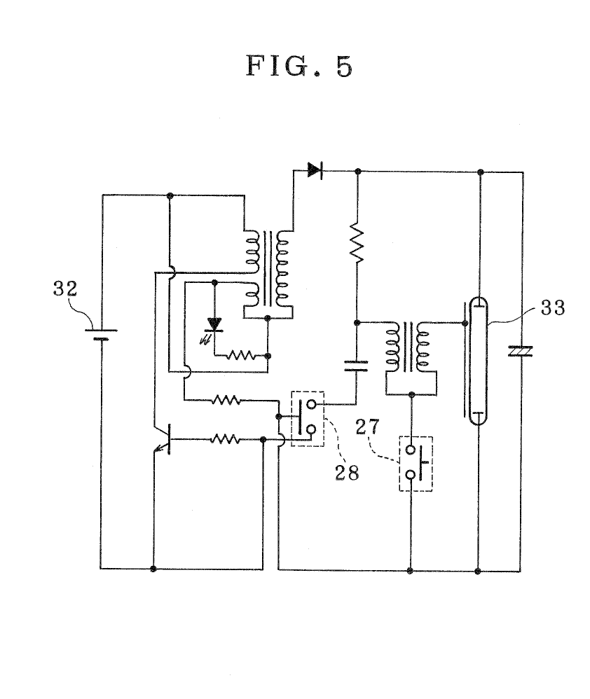

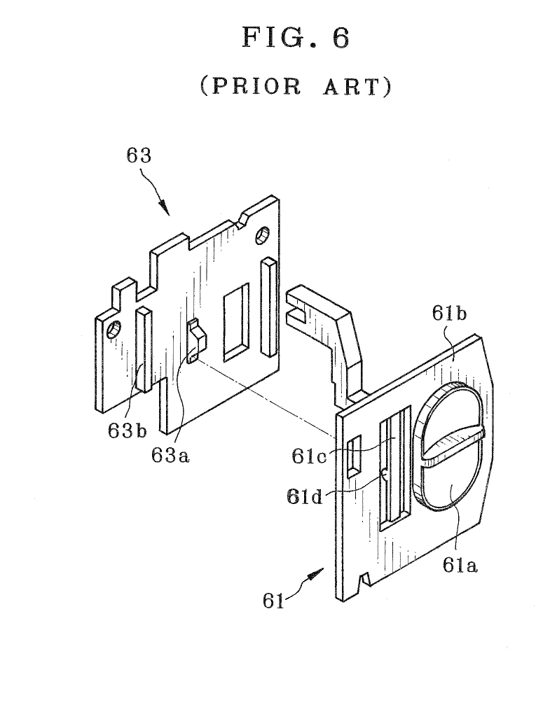

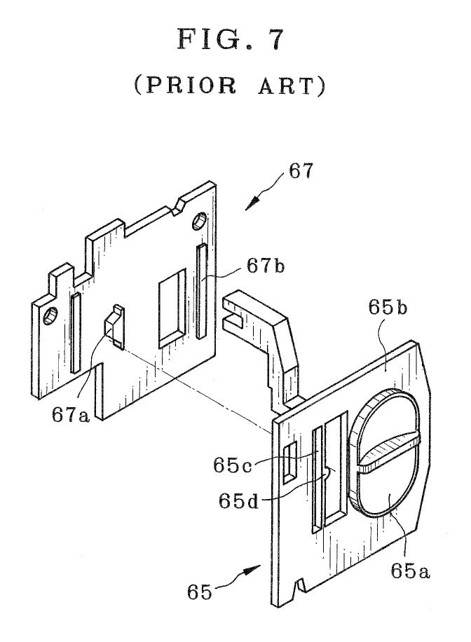

A flash device 24 as light source includes a main capacitor 25, the flash light source 6 and a flash circuit board 30 as charger. Various circuit elements are mounted on the flash circuit board 30, including sync segments 27, a flash switch 28, and a pair of electrodes 29. A battery 32 is squeezed and held by the electrodes 29. A flash discharge tube 33 as light source in the flash light source 6 of FIG. 5 is caused to emit flash light when the sync segments 27 become interconnected. The flash switch 28 is turned on when the sliding mechanism 5 slides up, and is turned off when the sliding mechanism 5 slides down.

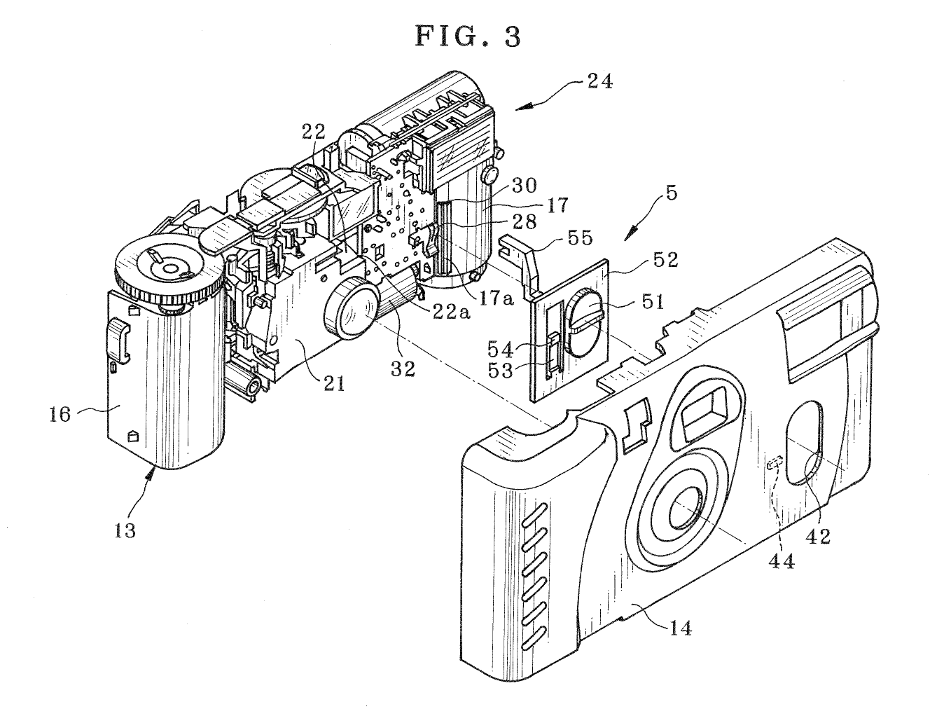

In FIG. 3, the sliding mechanism 5 is constituted by a support panel 52 in a switch device, and includes a button projection 51 or operation projection, and a connector 55. The button projection 51 is inserted through an opening 42 in the front cover 14 to appear externally. The connector 55 is coupled with the flash indicator 10. A ridge and recess are formed in the button projection 51 for facilitating a manual touch of a finger for moving the sliding mechanism 5. A guide rail 17a is formed on an outer wall of the photo film holder chamber 17. A guide rail 22a is formed on an outer wall of the light tunnel 22. Lateral sides of the support panel 52 are supported by the guide rails 17a and 22a, so the support panel 52 is slidable between the on and off positions by operation of the button projection 51.

A lock arm 53 as safe lock is formed to project from an opening of the support panel 52, and deformable flexibly. An engaging projection 54 is formed with an end of the lock arm 53. A positioning projection 44 is formed on the rear of the front cover 14. When the sliding mechanism 5 moves between the on and off positions, the engaging projection 54 moves to pass the positioning projection 44.

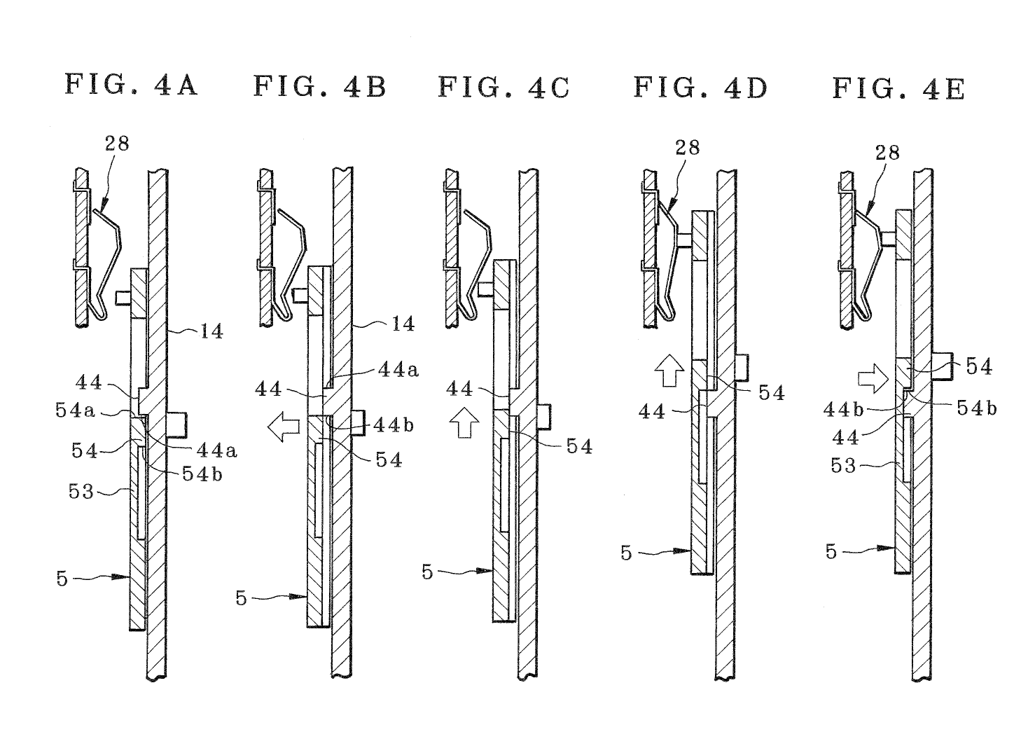

With reference to FIGS. 4A-4E, movement of the lock arm 53, the engaging projection 54 and the positioning projection 44 is described at the time of moving of the sliding mechanism 5 from the off position to the on position. In FIG. 4A, the off position is illustrated. Engaging faces 44a and 44b are formed with the positioning projection 44, and are oriented vertical to the sliding direction. A contact face 54a is formed with the engaging projection 54, and is positioned on a path of the engaging face 44a, and is oriented crosswise to the sliding direction. If incidental external force is applied to the sliding mechanism 5 in the sliding direction, the contact face 54a is blocked by the engaging face 44a of engagement. The lock arm 53 does not flex because the engaging face 44a and the engaging projection 54 extend perpendicularly to the slide of the sliding mechanism 5. The sliding mechanism 5 will not move even upon reception of strong external force.

To charge the flash unit for photographing, the button projection 51 in the off position is pushed by a finger and moved to the on position. The contact face 54a comes to contact the engaging face 44a. The sliding mechanism 5 does not move in the sliding direction. The support panel 52 becomes flexed to shift its center away from the front cover 14 or outer cover by a component of force directed toward the main body 13, the component being included in the force applied to the button projection 51. The lock arm 53 with the engaging projection 54 at the center moves away from the front cover 14. The engaging face 44a is disengaged from the contact face 54a to move the sliding mechanism 5 to the on position. See FIGS. 4C-4E.

Also, incidental movement of the sliding mechanism 5 is likely to occur in the on position if a finger touches the sliding mechanism 5 during exposure. In FIG. 4E, the on position is illustrated. A second contact face 54b of the engaging projection 54 contacts the second engaging face 44b, to keep the sliding mechanism 5 from moving incidentally. The movement of the engaging projection 54 while the sliding mechanism 5 moves from the on position to the off position is similar to that from the off position to the on position.

In FIG. 5, circuit elements for the flash device 24 in the lens-fitted photo film unit 2 are illustrated.

In the embodiment, the engaging projection 54 is disposed at the end of the lock arm 53 to prevent the sliding mechanism 5 from moving inadvertently from the on position to the off position. However, the switch device of the invention can be only for keeping the sliding mechanism 5 in the off position. This is because inadvertent shift from the on position will not cause a problem of consumption of power or the like, and because the off state will be informed by the flash indicator 10 immediately. Therefore, the lock arm 53 may have no engaging projection 54. An end face of the lock arm 53 may be the contact face.

Also, a switch device may include tilted surfaces with a small inclination formed in place of the second engaging face 44b and the second contact face 54b.

It is to be noted that an electric instrument of the invention may be any suitable one of various devices other than the lens-fitted photo film unit 2 of which a switch device should be locked in the off position, for example, a compact camera for silver halide photography, digital still camera and other electronic instruments, a light source assisted instrument having a light source such an emergency lamp, torch and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A switch device, including an operation projection disposed to project through an outer cover for covering a main body having a light source, said operation projection being slid to turn on and off a power source of said light source, said switch device comprising:
a sliding mechanism, having a front surface where said operation projection is formed, and having a flexible support panel of which two lateral edges are set on a front surface of said main body in a slidable manner, there being a space between said support panel and said main body behind said operation projection, said support panel being movable between on and off positions with said operation projection inside said outer cover;
a switch, disposed on said main body, for turning off said power source when said sliding mechanism is in said off position, and for turning on said power source when said sliding mechanism is shifted to said on position from said off position;
a positioning projection, disposed to project from an inner surface of said outer cover toward said sliding mechanism, and having an engaging face oriented crosswise to moving of said sliding mechanism;
a lock portion, formed on said support panel, and having a contact surface for contacting said engaging face when said sliding mechanism is in said off position, to prevent said sliding mechanism from moving toward said on position;
wherein when said operation projection is pressed toward said main body while said sliding mechanism is in said off position, said support panel flexes toward said main body to shift said lock position toward said main body, and said sliding mechanism is allowed to move to said on position by disengagement of said contact face from said engaging face.

2. A switch device as defined in claim 1, wherein said positioning projection has a second engaging face formed in a position in a sliding direction of said sliding mechanism, and oriented opposite from said engaging face;
said lock portion has a second contact face for contacting said second engaging face;
while said sliding mechanism is in said on position, said support panel in pressing said operation projection toward said main body flexes toward said main body, to shift said lock portion toward said main body, to allow said sliding mechanism to move to said off position by disengaging said second contact face from said second engaging face.

3. A switch device as defined in claim 2, further comprising a flexible lock arm, having a proximal end formed on said support panel, disposed to extend in said sliding direction, and having a distal end where said lock portion is formed.

4. A switch device as defined in claim 3, wherein a slot is formed in said support panel, and said lock arm projects from one end of said slot and extends along said slot.

5. A switch device as defined in claim 1, further comprising a light source circuit for charging power for said light source, wherein said switch turns on and off said light source circuit.

6. A lens-fitted photo film unit including a main body, an outer cover for covering said main body, a light source secured to said main body, and an operation projection disposed to project through said outer cover, and slid to turn on and off a power source of said light source, said lens-fitted photo film unit comprising:
a sliding mechanism, having a front surface where said operation projection is formed, and having a flexible support panel of which two lateral edges are set on a front surface of said main body in a slidable manner, there being a space between said support panel and said main body behind said operation projection, said support panel being movable between on and off positions with said operation projection inside said outer cover;
a switch, disposed on said main body, for turning off said power source when said sliding mechanism is in said off position, and for turning on said power source when said sliding mechanism is shifted to said on position from said off position;
a positioning projection, disposed to project from an inner surface of said outer cover toward said sliding mechanism, and having an engaging face oriented crosswise to moving of said sliding mechanism;
a lock portion, formed on said support panel, and having a contact surface for contacting said engaging face when said sliding mechanism is in said off position, to prevent said sliding mechanism from moving toward said on position;
wherein when said operation projection is pressed toward said main body while said sliding mechanism is in said off position, said support panel flexes toward said main body to shift said lock position toward said main body, and said sliding mechanism is allowed to move to said on position by disengagement of said contact face from said engaging face.

7. A lens-fitted photo film unit as defined in claim 6, wherein said positioning projection has a second engaging face formed in a position in a sliding direction of said sliding mechanism, and oriented opposite from said engaging face;
said lock portion has a second contact face for contacting said second engaging face;
while said sliding mechanism is in said on position, said support panel in pressing said operation projection toward said main body flexes toward said main body, to shift said lock portion toward said main body, to allow said sliding mechanism to move to said off position by disengaging said second contact face from said second engaging face.

8. A lens-fitted photo film unit as defined in claim 7, further comprising a flexible lock arm, having a proximal end formed on said support panel, disposed to extend in said sliding direction, and having a distal end where said lock portion is formed.

9. A lens-fitted photo film unit as defined in claim 8, wherein a slot is formed in said support panel, and said lock arm projects from one end of said slot and extends along said slot.

10. A lens-fitted photo film unit as defined in claim 6, further comprising a light source circuit for charging power for said light source, wherein said switch turns on and off said light source circuit.
